(19) United States
(12) Patent Application Publication
(10) Pub. No.: US 2025/0374175 A1
(43) Pub. Date: Dec. 4, 2025

(54) METHOD AND APPARATUS FOR PLMN SEARCH AND SELECTION AFTER REMOVAL OF ENTRY IN WIRELESS NETWORK

(71) Applicant: SAMSUNG ELECTRONICS CO., LTD., Suwon-si, Gyeonggi-do (KR)

(72) Inventors: Lalith KUMAR, Bangalore (IN); Aman AGARWAL, Bangalore (KR); Avneesh TIWARI, Bangalore (KR); Kailash Kumar JHA, Bangalore (IN); Mahmoud WATFA, Staines, Middlesex (GB)

(21) Appl. No.: 18/874,661

(22) PCT Filed: Jun. 14, 2023
(86) PCT No.: PCT/KR2023/008202

§ 371 Date: Dec. 13, 2024

(30) Foreign Application Priority Data
Jun. 16, 2022 (IN) 202241034607
May 18, 2023 (IN) 202241034607

(51) Int. Cl. H04W 48/18; H04W 4/90; H04W 8/18; H04W 48/04; H04W 64/00; H04W 84/04; H04W 84/06

(52) U.S. Cl. CPC H04W 48/18; H04W 4/90; H04W 8/183; H04W 48/04; H04W 64/00; H04W 84/042; H04W 84/06

(57) ABSTRACT

The disclosure relates to a 5G or 6G communication system for supporting a higher data transmission rate. Embodiments herein provide a method for PLMN search and selection after removal of a candidate PLMN in a wireless network by a UE. The method includes identifying that the UE is in a limited service state. Further, the method includes identifying that an entry of at least one candidate public land mobile network (PLMN) from a list of PLMNs not allowed to operate at a current location of the UE is removed. Further, the method includes triggering a PLMN selection in case that the entry is removed from the list of PLMNs and the UE is in the limited service state.

### TECHNICAL FIELD

The present disclosure relates to a wireless network, and more particularly to a method and a User Equipment (UE) for Public Land Mobile Network (PLMN) search and selection after removal of an entry in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6G Hz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra- high-performance communication and computing resources.

### DISCLOSURE OF INVENTION

### Technical Problem

The purpose of this application is to be able to solve at least one of the drawbacks of the prior art.

There was no further action or behaviour specified or defined in a 3GPP system for the MS or UE with respect to the PLMN list handling after the removal or deletion of the PLMNs from the list of “PLMNs not allowed to operate at the present UE location” in case that the UE is in limited state. Hence a method needs to be defined. It is desired to address the above mentioned disadvantages or other short comings or at least provide a useful alternative.

### Solution to Problem

Accordingly, the embodiment herein is to provide a method performed by a user equipment (UE) for PLMN search and selection after removal of a candidate PLMN in a wireless network. The method includes identifying that the UE is in a limited service state. Further, the method includes identifying that an entry of at least one candidate public land mobile network (PLMN) from a list of PLMNs not allowed to operate at a current location of the UE is removed. Further, the method includes triggering a PLMN selection in case that the entry is removed from the list of PLMNs and the UE is in the limited service state.

In an embodiment, the entry is removed from the list of PLMNs in case that the UE is successfully registered via the satellite next generation radio access network (NG-RAN) access technology to a PLMN stored in the entry and UE is not registered for emergency services.

In an embodiment, the entry is removed from the list of PLMNs in case that a timer instance associated with the entry is expired.

In an embodiment, the entry is removed from the list of PLMNs in case that current UE location is known, a geographical location is stored in the UE for the entry and a distance from the geographical location to the current UE location is larger than a third value.

Accordingly, the embodiment herein is to provide a UE for PLMN search and selection after removal of a candidate PLMN in a wireless network. The UE includes a controller communicatively coupled to a communicator. The controller is configured to detect identify that the UE is in a limited service state. Further, the controller is configured to identify that an entry of at least one candidate public land mobile network (PLMN) from a list of PLMNs not allowed to operate at a current location of the UE is removed. Further, the controller is configured to trigger a PLMN selection in case that the entry is removed from the list of PLMNs and the UE is in the limited service state.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

The principal object of the embodiments herein is to provide a method and a UE for PLMN search and selection after removal of a candidate PLMN in a wireless network.

Another object of the embodiments herein is to provide that the proposed method expects the UE to not take any action when an entry is removed from the list, whereas the UE is already in a normal service state and receiving services from a PLMN.

Another object of the embodiments herein is to provide that a trigger is defined for the UE to perform PLMN selection when the entry is deleted from the list, the UE is in a limited services state and is not getting any service.

Another object of the embodiments herein is to provide that the UE continues to be in the limited service state when the entry is not deleted from the list, the UE is in the limited services state and is not getting any service.

Another object of the embodiments herein is to provide that the UE performs the PLMN selection, when the PLMN entry is deleted from the list and if the UE is in a 5GMM-DEREGISTERED.LIMITED-SERVICE state.

### BRIEF DESCRIPTION OF DRAWINGS

The method and the UE are illustrated in the accompanying drawings, throughout which like reference letters indicate corresponding parts in the various figures. The embodiments herein will be better understood from the following description with reference to the drawings, in which:

FIG. 1 is a flow chart illustrating a scenario of interface between a plurality of PLMNs and a UE;

FIG. 2 shows various hardware components of the UE, according to the embodiments as disclosed herein;

FIG. 3 is a flow chart illustrating a method for PLMN search and selection after removal of a candidate PLMN in a wireless network, according to the embodiments as disclosed herein;

FIG. 4 is a flow chart illustrating a scenario of proposed interface between the plurality of PLMNs and the UE, according to the embodiments as disclosed herein; and

FIG. 5 is another flow chart scenario illustrating interface between the plurality of PLMNs and the UE, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for PLMN search and selection after removal of a candidate PLMN in a wireless network.

In the embodiment, when the timer instance associated with any one or more than one of the entry expires or if the current UE location is known, a geographical location is stored for the entry of any one or more than one the PLMN, and the distance to the current UE location is larger than a UE implementation specific value for any one or more than one of the PLMN, in the proposed method, the UE triggers the PLMN search and PLMN selection when the UE is in the limited service state. In another embodiment, the UE avoids triggering PLMN search and PLMN selection when the UE is in a normal service state. In an alternate embodiment, the UE considers triggering PLMN search and PLMN selection when the UE is in the normal service state.

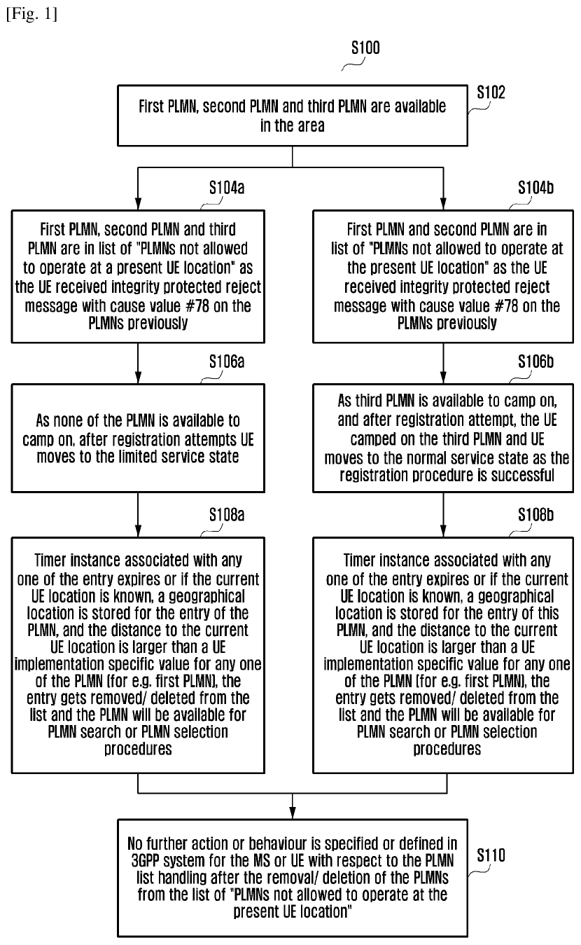

Referring now to the drawings and more particularly to FIGS. 1 through 5, where similar reference characters denote corresponding features consistently throughout the figures, there are shown preferred embodiments.

For a Third Generation Partnership Project (3GPP) satellite Next Generation Radio Access Network (NG-RAN), a UE stores a list of “PLMNs not allowed operating at a present UE location”. Each entry consists of:
a) a PLMN identity (ID) of the PLMN which sent a message including a fifth generation Non-access stratum (5G NAS) Mobility Management (5GMM) cause value #78 “PLMN not allowed to operate at the present UE location” via a satellite NG-RAN access technology;
b) a geographical location, if known by the UE, where the 5GMM cause value #78 was received on the satellite NG-RAN access technology; and
c) a UE implementation specific distance value, if the geographical location exists.
   The UE implementation specific distance value is not be set to a value smaller than a value indicated by a wireless network, if any.

Before storing a new entry in the list, the UE deletes any existing entry with the same PLMN identity. Upon storing a new entry, the UE starts a timer instance associated with the entry with an implementation specific value that shall not be set to a value smaller than the timer value indicated by the wireless network. The UE is allowed to attempt to access the PLMN via the satellite NG-RAN access technology which is part of the list of “PLMNs not allowed to operate at the present UE location” only if:
a) the current UE location is known, the geographical location is stored for the entry of the PLMN, and a distance to the current UE location is larger than the UE implementation specific value. The UE implementation specific value shall not be set to the value smaller than the value indicated by the network;
b) the timer associated with the entry of the PLMN has expired; or
c) the access is for emergency services.

The list accommodates three or more entries. The maximum number of entries is an implementation decision. When the list is full and a new entry has to be inserted, the oldest entry is deleted. Each entry is removed if for the entry:
a) the UE successfully registers via the satellite NG-RAN access technology to the PLMN stored in the entry; or
b) the timer instance associated with the entry expires.

The UE may delete the entry in the list, if the current UE location is known, the geographical location is stored for the entry of the PLMN, and the distance to the current UE location is larger than the UE implementation specific value. When the UE is switched off, the UE keeps the list of “PLMNs not allowed to operate at the present UE location” in its non-volatile memory. The UE deletes the list of “PLMNs not allowed to operate at the present UE location” if a Universal Subscriber Identity Module (USIM) is removed.

In order to obtain service on the PLMN through the satellite NG-RAN access technology, the UE or a Mobile Station (MS) attempts to find a suitable cell in the PLMN following a PLMN search procedure. When the UE or the MS finds a suitable cell in the PLMN, the UE attempts to register on the PLMN. If the registration is successful, the UE camps on the suitable cell. Otherwise, the UE tries for the next PLMN. If the registration attempt on none of the PLMNs is successful, the UE enters a limited service state. When in the limited service state, the UE can only originate emergency calls or receive an Earthquake and Tsunami Warning System (ETWS) message. If the registration attempt on any one of the PLMN is successful, the UE enters the normal service state. When the UE or MS receives an integrity protected reject message for the PLMN with the cause value #78 “PLMNs not allowed to operate at the present UE location” from a satellite NG-RAN cell, the UE or the MS maintains the list of “PLMNs not allowed to operate at the present UE location”. Now if for one or more of the PLMNs, from the list of “PLMNs not allowed to operate at the present UE location”, timer instance associated with the entry expires or if the current UE location is known, the geographical location is stored for the entry of the PLMN, and the distance to the current UE location is larger than the UE implementation specific value, the PLMN entries gets removed/deleted from the list of “PLMNs not allowed to operate at the present UE location.”

There is no further action or behaviour is specified or defined in a 3GPP system for the MS or UE with respect to the PLMN list handling after the removal/deletion of the PLMNs from the list of “PLMNs not allowed to operate at the present UE location” when after timer instance associated with the entry expires or if the current UE location is known, the geographical location is stored for the entry of the PLMN, and the distance to the current UE location is larger than the UE implementation specific value, the UE is in limited state or normal service state. Hence a method needs to be defined in the 3GPP system.

FIG. 1 is a flow chart (S100) illustrating a scenario of interface between the plurality of PLMNs and the UE. At step S102, a first PLMN, a second PLMN and a third PLMN are available in an arca. At step S104a, the first PLMN, the second PLMN and the third PLMN are in the list of “PLMNs not allowed to operate at the present UE location” as the UE received integrity protected reject message with the cause value #78 on the PLMNs previously.

At step S106a, as none of the PLMN is available to camp on, after registration attempts, the UE moves to the limited service state. At step S108a, when timer instance associated with any one of the entry expires or if the current UE location is known, the geographical location is stored for the entry of the PLMN, and the distance to the current UE location is larger than the UE implementation specific value for any one of the PLMN (for e.g. first PLMN), the entry gets removed/deleted from the list and the PLMN will be available for PLMN search or PLMN selection procedures.

Alternatively, At step S102, the first PLMN, the second PLMN and the third PLMN are available in the area. At step S104b, the first PLMN and the second PLMN are in the list of “PLMNs not allowed to operate at the present UE location” as the UE received integrity protected reject message with cause value #78 on these PLMNs previously.

At step S106b, as the third PLMN is available to camp on, and after registration attempt, the UE camped on the third PLMN, and the UE moves to the normal service state. At step S108b, when timer instance associated with any one of the entry expires or if the current UE location is known, the geographical location is stored for the entry of the PLMN, and the distance to the current UE location is larger than the UE implementation specific value for any one of the PLMN (for e.g. first PLMN), the entry gets removed/deleted from the list and the PLMN will be available for PLMN search or PLMN selection procedures.

At step S110, there is no further action or behaviour is specified or defined in the 3GPP system for the MS or UE with respect to the PLMN list handling after the removal/deletion of the PLMNs from the list of “PLMNs not allowed to operate at the present UE location” when the UE is in the normal service state. Hence a method needs to be defined in the 3GPP system.

FIG. 2 shows various hardware components of a UE (100), according to the embodiments as disclosed herein. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. In an embodiment, the UE (100) includes a processor (110), a communicator (120), a memory (130) and a PLMN removal controller (140). The processor (110) is coupled with the communicator (120), the memory (130) and the PLMN removal controller (140).

The PLMN removal controller (140) detects an entry of a candidate PLMN from a list of PLMNs not allowed to operate at a current location of the UE (100) is removed. In another embodiment, the candidate PLMN from the list of PLMNs not allowed to operate at the current location of the UE (100) is removed when the current location of the UE (100) is known, a geographical location is stored for the entry of the candidate PLMN, and a distance to the current location of the UE (100) is larger than a UE implementation specific value.

In an embodiment, the PLMN removal controller (140) determines whether one of “the UE (100) is successfully registered via a satellite NG-RAN access technology to the PLMN stored in the entry except when the UE (100) registers for emergency services” and “a timer instance associated with the entry is expired”. Further, the PLMN removal controller (140) removes the entry of the candidate PLMN from the list of PLMNs not allowed to operate at the current location of the UE (100) when one of the UE (100) is successfully registered and the timer instance associated with the entry is expired.

Further, the PLMN removal controller (140) determines whether the UE (100) is in one of the limited service state or the normal service state. In an embodiment, the PLMN removal controller (140) triggers one of the PLMN search and the PLMN selection on determining that the candidate PLMN is removed when the UE (100) is in the limited service state. In another embodiment, the PLMN removal controller (140) avoids triggering of one of a PLMN search and the PLMN selection on determining that the candidate PLMN is removed when the UE (100) is in the normal service state.

The PLMN removal controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

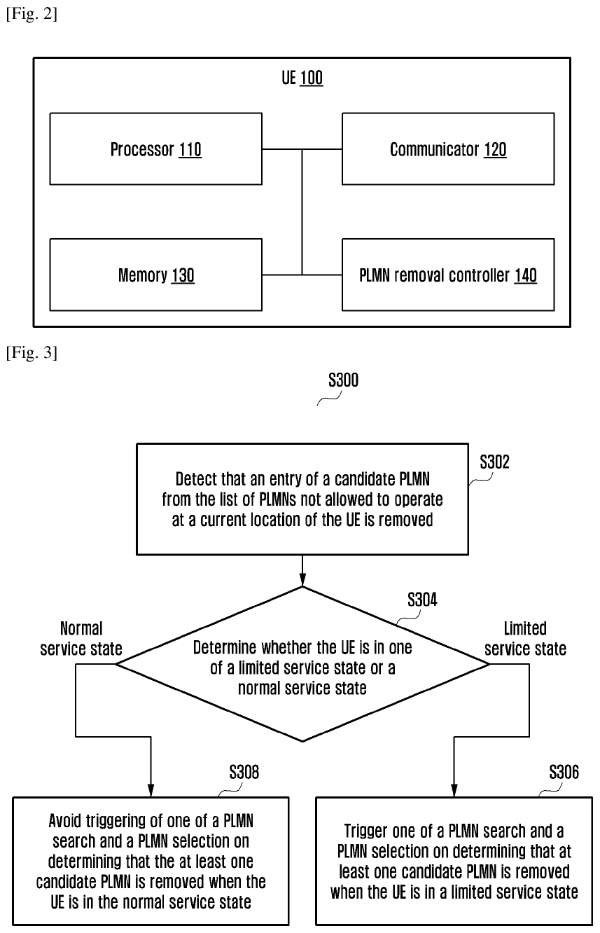

FIG. 3 is a flow chart (S300) illustrating a method for the PLMN search and selection after removal of the candidate PLMN in the wireless network (not shown), according to the embodiments as disclosed herein. The wireless network can be, for example, but not limited to a fourth generation (4G) network, a fifth generation (5G) network, an Open Radio Access Network (ORAN) or the like. The operations (S302-S308) are handled by the PLMN removal controller (140).

At step S302, the method includes detecting that the entry of the candidate PLMN from the list of PLMNs not allowed to operate at the current location of the UE (100) is removed. At step S304, the method includes determining whether the UE (100) is in one of the limited service state or the normal service state. At step S306, the method includes triggering one of the PLMN search and the PLMN selection on determining that the candidate PLMN is removed when the UE (100) is in the limited service state. At step S308, the method includes avoiding triggering of one of the PLMN search and the PLMN selection on determining that the candidate PLMN is removed when the UE (100) is in the normal service state.

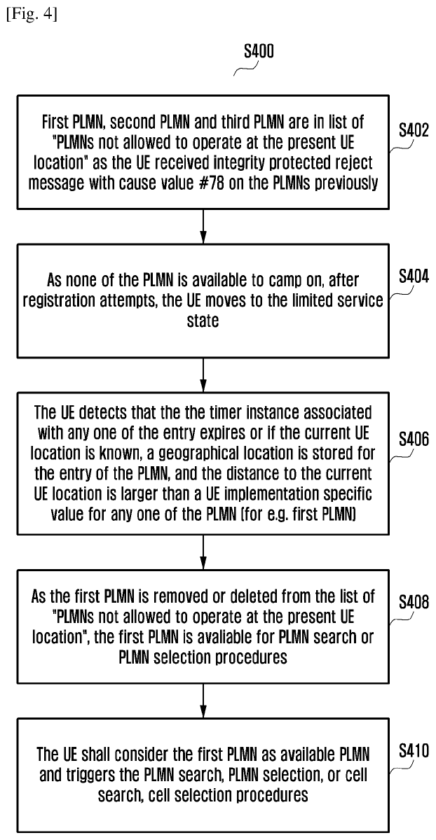

FIG. 4 is a flow chart (S400) illustrating a scenario of proposed interface between the plurality of PLMNs and the UE (100), according to the embodiments as disclosed herein.

At step S402, when the first PLMN, the second PLMN and the third PLMN are available PLMNs in the area and the UE (100) attempted on all of them but, the UE (100) or the MS gets integrity protected reject message for all these PLMN with cause value #78 “PLMNs not allowed to operate at the present UE location” from a satellite NG-RAN cell.

At step S404, the UE (100) or the MS enters the limited service state (i.e. one of the 5GMM-REGISTERED.LIMITED-SERVICE or 5GMM-DEREGISTERED.LIMITED-SERVICE) or it can be any state where UE is not getting any service. At step S406, the timer instance associated with any one of the entry expires or if the current UE location is known, the geographical location is stored for the entry of the PLMN, and the distance to the current UE location is larger than the UE implementation specific value for any one of the PLMN (for e.g. the first PLMN).

At step S408, in general, the first PLMN is removed or deleted from the list of “PLMNs not allowed to operate at the present UE location” for any of the reasons or the complete list of “PLMNs not allowed to operate at the present UE location” is deleted then the first PLMN is available for the PLMN search or the PLMN selection procedures.

At step S410, now, the UE (100) considers the first PLMN as available PLMN and triggers the PLMN search and the PLMN selection or attempt on the PLMNs for PLMN search and PLMN selection. That is, the UE (100) performs the cell selection (i.e. on 3GPP access) or cell reselection according to a 3GPP TS 38.304 or a 3GPP TS 36.304 or performs the PLMN selection procedure as defined in a 3GPP TS 23.122.

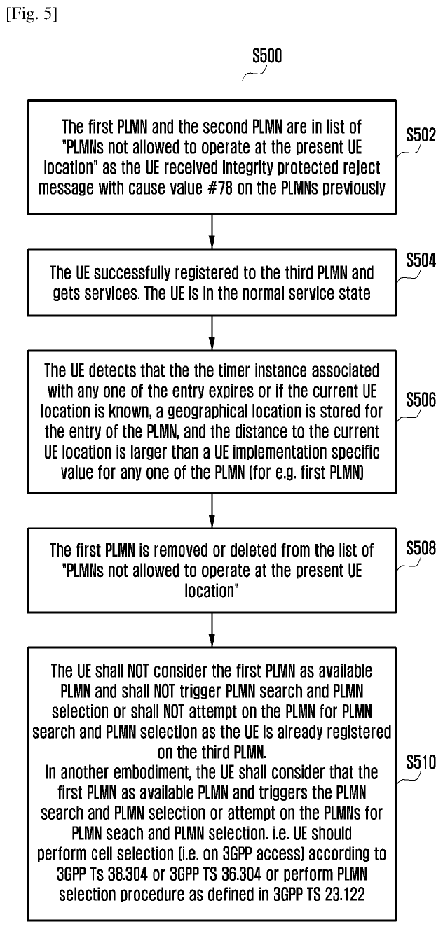

FIG. 5 is another flow chart (S500) illustrating interface between the plurality of PLMNs and the UE (100), according to the embodiments as disclosed herein.

At step S502, if the first PLMN, the second PLMN and the third PLMN are available PLMNs in the area and the UE (100) is attempted on all of them and the UE (100) or the MS gets integrity protected reject message for the first PLMN and the second PLMN with the cause value #78 “PLMNs not allowed to operate at the present UE location” from the satellite NG-RAN cell. The two PLMNs are added to the list of “PLMNs not allowed to operate at the present UE location” along with UE's geographical location and the UE implementation specific distance value. Also, the UE (100) starts a corresponding timer instances for the PLMNs.

At step S504, the UE (100) or the MS attempts registration on the third PLMN and gets successfully registered on the third PLMN and moves to the normal service state (i.e. 5GMM-REGISTERED.NORMAL-SERVICE) from a PLMN search state i.e. in general not in the limited service state.

At step S506, the UE (100) detects that the timer instance associated with any one of the entry expires or if the current UE location is known, the geographical location is stored for the entry of the PLMN, and the distance to the current UE location is larger than the UE implementation specific value for any one of the PLMN (for e.g. first PLMN).

At step S508, in general, the first PLMN is removed or deleted from the list of “PLMNs not allowed to operate at the present UE location” for any of the reasons or the complete list of “PLMNs not allowed to operate at the present UE location” is deleted.

At step S510, now, the UE (100) shall not consider the first PLMN for triggering PLMN search and PLMN selection or shall not attempt on the first PLMN for PLMN search and PLMN selection as the UE (100) is already registered on the third PLMN.

In yet another embodiment, the UE (100) considers the first PLMN as available PLMN and triggers the PLMN search and PLMN selection or attempt on the PLMNs for the PLMN search and PLMN selection. That is, the UE (100) performs the cell selection (i.e. on 3GPP access) or the cell reselection according to the 3GPP TS 38.304 or the 3GPP TS 36.304 or perform the PLMN selection procedure as defined in the 3GPP TS 23.122.

In yet another embodiment, if the UE (100) determines that the UE (100) is in a discontinuous coverage (DC) and the UE (100) is in a NO CELL AVAILABLE or a PLMN search sub-state, and the timer instance associated with any one of the entry expires or if the current UE location is known, the geographical location is stored for the entry of the PLMN, and the distance to the current UE location is larger than the UE implementation specific value for any one of the PLMN in the list of “PLMNs not allowed to operate at the present UE location”, the UE (100) avoids triggering the PLMN search and the PLMN selection.

In yet another embodiment, if the UE (100) determines that the UE (100) is in the discontinuous coverage and it is not in NO CELL AVAILABLE state or the PLMN search sub-state, and the timer instance associated with any one of the entry expires or if the current UE location is known, the geographical location is stored for the entry of the PLMN, and the distance to the current UE location is larger than the UE implementation specific value for any one of the PLMN in the list of “PLMNs not allowed to operate at the present UE location”, the UE (100) may or may not trigger PLMN search and PLMN selection.

In an embodiment, terms “removed” and “deleted” are used interchangeably and refer to the same thing in the patent disclosure.

The UE (100)/the network may select one or more of the stated solutions in any random order.

The issues/solutions proposed in the embodiment are explained using the satellite NG-RAN access technology. However, the solutions proposed in the embodiment are also applicable for a satellite E-UTRAN access technology, a NB (Narrow Band)-S1 mode or a Wide Band (WB). The issues/solutions proposed in the embodiment are also applicable for any kind of services such as a normal service, an emergency service, a SNPN, a NPN, an e-NPN, a LADN, a MEC etc. (Wide Band)-S1 mode via satellite E-UTRAN access and/or NB-IOT (NarrowBand Internet Of Things) or WB-IOT (WideBand Internet Of Things) Satellite Access/Architecture.

The issues/solutions proposed in the embodiment are also applicable for any kind of services such as normal service, emergency service, SNPN, NPN, e-NPN, LADN, MEC etc.

The network used in the embodiment is explained using any 5G Core Network Function for e.g. Access and Mobility Management Function (AMF). However, the network could be any fifth generation (5G)/Evolved Universal Mobile Telecommunication Access Network (EUTRAN) Core Network Entities like AMF/Session Management Function (SMF)/Mobility Management Entity (MME)/User Plane Function (UPF) or the Network could be any 5G/EUTRAN RAN Entity like eNodeB (eNB) or gNodeB (gNB) or NG-RAN etc.

In an embodiment, the NR Satellite Access Network, Satellite Access Network and Satellite NG-RAN access technology are interchangeably used and have the same meaning.

The various actions, acts, blocks, steps, or the like in the flow charts (S100, S300-S500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein. Claims

1. A method performed by a user equipment (UE) in a non-terrestrial network, the UE comprising:
identifying whether the UE is in a limited service state;
identifying whether an entry of a public land mobile network (PLMN) from a list of PLMNs not allowed to operate at a current location of the UE is removed; and
performing a PLMN selection in case that the entry is removed from the list of PLMNs and the UE is in the limited service state.

2. The method of claim 1, further comprising:
removing the entry from the list of PLMNs in case that the UE is successfully registered via the satellite next generation radio access network (NG-RAN) access technology to a PLMN stored in the entry and UE is not registered for emergency services.

3. The method of claim 1, further comprising:
removing the entry from the list of PLMNs in case that a timer instance associated with the entry is expired.

4. The method of claim 3,
wherein the timer instance is set to a first value that is not smaller than a second value indicated by a network.

5. The method of claim 1, further comprising:
removing the entry from the list of PLMNs in case that current UE location is known, a geographical location is stored in the UE for the entry and a distance from the geographical location to the current UE location is larger than a third value.

6. method of claim 1,
wherein the list of PLMNs is stored in non-volatile memory of the UE in case that the UE is switched off.

7. The method of claim 1,
wherein the list of PLMNs is deleted from the UE in case that a universal subscriber identity module (USIM) is removed from the UE.

8. A user equipment (UE) in a non-terrestrial network, the UE comprising:
a communicator; and
a controller, configured to:
identify whether the UE is in a limited service state,
identify whether an entry of a public land mobile network (PLMN) from a list of PLMNs not allowed to operate at a current location of the UE is removed, and
perform a PLMN selection in case that the entry is removed from the list of PLMNs and the UE is in the limited service state.

9. The UE of claim 8,
wherein the controller is further configured to:
remove the entry from the list of PLMNs in case that the UE is successfully registered via the satellite next generation radio access network (NG-RAN) access technology to a PLMN stored in the entry and UE is not registered for emergency services.

10. The UE of claim 8,
wherein the controller is further configured to:
remove the entry from the list of PLMNs in case that a timer instance associated with the entry is expired.

11. The UE of claim 10,
wherein the timer instance is set to a first value that is not smaller than a second value indicated by a network.

12. The UE of claim 8,
wherein the controller is further configured to:
remove the entry from the list of PLMNs in case that current UE location is known, a geographical location is stored in the UE for the entry and a distance from the geographical location to the current UE location is larger than a third value.

13. The UE of claim 8,
wherein the list of PLMNs is stored in non-volatile memory of the UE in case that the UE is switched off.

14. The UE of claim 8,
wherein the list of PLMNs is deleted from the UE in case that a universal subscriber identity module (USIM) is removed from the UE.
